(19) United States
(12) Patent Application Publication
(10) Pub. No.: US 2002/0093690 A1
(43) Pub. Date: Jul. 18, 2002

(54) Communication device having a keyboard adopting a changeable character layout

(76) Inventor: Kazuhiro Satoh, Kanagawa (JP)

Correspondence Address: RICHARD F. JAWORSKI, Cooper & Dunham LLP, 1185 Avenue of the Americas, New York, NY, 10036, US

(21) Appl. No.: 10/083,211

(22) Filed: Oct. 19, 2001

(30) Foreign Application Priority Data
Oct. 31, 2000 (JP) 2000-332296
Jun. 28, 2001 (JP) 2001-196904

(51) Int. Cl. H04N 1/00

(52) U.S. Cl. 358/400; 358/440

(57) ABSTRACT

A communication device is provided. The communication device comprises a keyboard used to input literal information. In the communication device, a character allocated to each of keys provided on the keyboard can be changed. In the communication device, the character may be allocated to each of the keys according to a predetermined keyboard character layout. In the communication device, the predetermined keyboard character layout may be selected from among a plurality of predetermined keyboard character layouts by a user.

### BACKGROUND OF THE INVENTION

1. Field of the Invention

The present invention generally relates to a communication device, and more particularly, to a communication device having a keyboard to input literal information, and a communication device having a numeric keypad to input numeric information.

2. Description of the Related Art

Conventionally, a communication device, such as a facsimile device, has a destination-registration function to register destination information, which, in combination with a one-touch dial function, provides a simple and convenient operation for a user to select a destination.

For example, when a facsimile number (telephone number) of a destination is registered for a one-touch dial key of the one-touch dial function, a name, etc. of the destination can be also registered for the one-touch dial key.

Then, when the one-touch dial key is operated, the registered name of the destination is displayed so that a user can easily confirm the destination.

Besides, the facsimile device involves other occasions of keying in literal information, such as the above-mentioned name of the destination; for example, when keying in self-terminal name information for the identification of the self-terminal.

Thus, such a communication device as above requires a user to key in literal information in various occasions.

In order for a user to key in literal information as above, an input means is necessary.

A conventional communication device includes a one-touch dial key unit as an input means having three rows of ten keys, for example, with characters, such as alphabetic letters, being allocated to each key in a certain character arrangement (layout). However, the mode of the above-mentioned character arrangement is fixed, which is difficult for some users to use.

### SUMMARY OF THE INVENTION

It is a general object of the present invention to provide an improved and useful communication device in which the above-mentioned problems are eliminated.

A more specific object of the present invention is to provide a communication device which is easy for a user to use when keying in literal information.

In order to achieve the above-mentioned objects, there is provided according to one aspect of the present invention a communication device comprising:

a keyboard used to input literal information, wherein a character allocated to each of keys provided on the keyboard can be changed.

Additionally, in the communication device according to the present invention, the character may be allocated to each of the keys according to a predetermined keyboard character layout.

Additionally, in the communication device according to the present invention, the predetermined keyboard character layout may be selected from among a plurality of predetermined keyboard character layouts by a user.

Additionally, in the communication device according to the present invention, configuration information regarding a configuration of the communication device may be obtained so that the predetermined keyboard character layout is selected according to the configuration information.

Additionally, in the communication device according to the present invention, situation information regarding a nation where the communication device is situated may be obtained so that the predetermined keyboard character layout is selected according to the situation information.

Additionally, in the communication device according to the present invention, configuration information regarding a configuration of the communication device may be obtained, and situation information regarding a nation where the communication device is situated may be obtained, so that the predetermined keyboard character layout is selected according to at least one of the configuration information and the situation information.

According to the present invention, the user can smoothly input, not only characters, but also necessary symbols.

In order to achieve the above-mentioned objects, there is provided according to one aspect of the present invention a communication device comprising:

a numeric keypad used to input numeric information, wherein a character allocated to each of keys provided on the numeric keypad can be changed.

Additionally, in the communication device according to the present invention, the character may be allocated to each of the keys according to a predetermined numeric-keypad character layout.

Additionally, in the communication device according to the present invention, the predetermined numeric-keypad character layout may be selected from among a plurality of predetermined numeric-keypad character layouts by a user.

According to the present invention, the user can input numerals smoothly.

Other objects, features and advantages of the present invention will become more apparent from the following detailed description when read in conjunction with the accompanying drawings.

### BRIEF DESCRIPTION OF THE DRAWINGS

FIG. 1 is a block diagram showing an example of a structure of a group-3 facsimile device according to an embodiment of the present invention;

FIG. 2 is a block diagram showing another example of a structure of the group-3 facsimile device according to the embodiment of the present invention;

FIG. 3 is a block diagram showing an example of a network system including the group-3 facsimile device;

FIG. 4 outlines an example of an operation/display unit of the group-3 facsimile device;

FIG. 5 shows an example of an ABC character arrangement;

FIG. 6 shows an example of a QWERTY character arrangement;

FIG. 7 shows an example of an Internet character arrangement;

FIG. 8 shows an example of a French character arrangement;

FIG. 9 shows an example of a standard numeric-keypad arrangement;

FIG. 10 shows an example of an extension numeric-keypad arrangement;

FIG. 11A shows an example of one-touch-keyboard control information;

FIG. 11B shows an example of a one-touch-keyboard key-map table;

FIG. 11C shows an example of one-touch-key key-map information;

FIG. 12A shows an example of numeric-keypad control information;

FIG. 12B shows an example of a numeric-keypad key-map table;

FIG. 12C shows an example of numeric-key key-map information;

FIG. 13 is a flowchart showing an example of a procedure when a user operates a one-touch dial keyboard of the operation/display unit;

FIG. 14 is a flowchart showing another example of a procedure when a user operates the one-touch dial keyboard;

FIG. 15 is a flowchart showing an example of a procedure when a user operates a numeric keypad of the operation/display unit;

FIG. 16 is a flowchart showing an example of a procedure of recording and outputting a label to be applied to an indication field of the one-touch dial keyboard;

FIG. 17 is a flowchart showing an example of a procedure of recording and outputting a label to be applied to an indication field of the numeric keypad;

FIG. 18A and FIG. 18B are plan views specifically showing an example of a structure in the vicinity of the one-touch dial keyboard; and

FIG. 19 is an explanatory view plainly showing an opening/closing of a one-touch switching plate.

### DETAILED DESCRIPTION OF THE PREFERRED EMBODIMENTS

A description will now be given, with reference to the drawings, of embodiments according to the present invention.

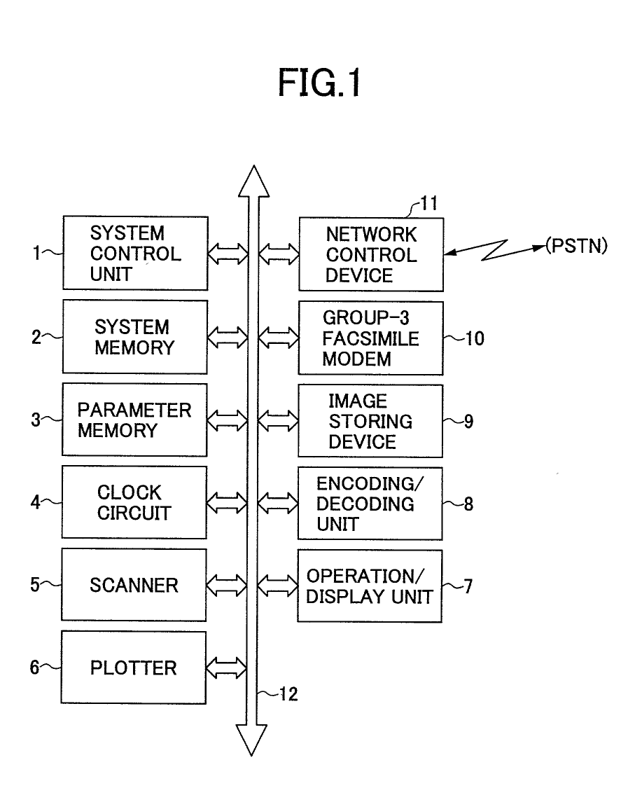

FIG. 1 is a block diagram showing a structure of a group-3 facsimile device according to an embodiment of the present invention.

In FIG. 1, a system control unit 1 performs a process of controlling each of units provided in this group-3 facsimile device, and performs a predetermined group-3-facsimile transmission control procedure process. A system memory 2 stores control process programs executed by the system control unit 1, and various types of data required when the process programs are executed, and forms a work area of the system control unit 1. A parameter memory 3 stores various types of information intrinsic to the group-3 facsimile device. A clock circuit 4 outputs current time information.

A scanner 5 reads a subject copy image with a predetermined resolution. A plotter 6 records and outputs an image with a predetermined resolution. An operation/display unit 7 comprises various types of operation keys and various types of displayer devices so as to operate this facsimile device.

An encoding/decoding unit 8 encodes and compresses an image signal, and decodes encoded and compressed image information to the original image signal. An image storing device 9 stores a multitude of encoded and compressed image information.

A group-3 facsimile modem 10 realizes a modem function of the group-3 facsimile device, and has a low-speed modem function (V.21 modem) to exchange a transmission procedure signal, and a high-speed modem function (V.17 modem, V.34 modem, V.29 modem, V.27 ter modem, etc.) to exchange image information.

A network control device 11 connects this group-3 facsimile device to an analog public switched telephone network (PSTN), and has an automatic calling/answering function.

The above-mentioned system control unit 1, the system memory 2, the parameter memory 3, the clock circuit 4, the scanner 5, the plotter 6, the operation/display unit 7, the encoding/decoding unit 8, the image storing device 9, the group-3 facsimile modem 10 and the network control device 11 are connected to an internal bus 12. These components exchange data mainly via this internal bus 12.

The network control device 11 and the group-3 facsimile modem 10 exchange data directly with each other.

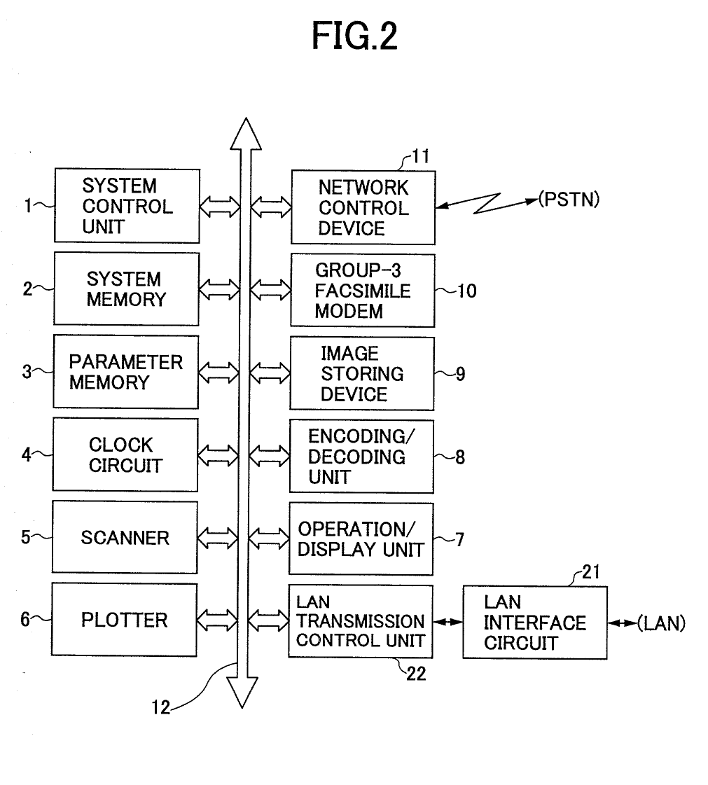

Besides, this group-3 facsimile device can be additionally equipped with a function to connect to a local area network (LAN) as an option. FIG. 2 shows an example of a structure (of a network facsimile device FX) in this case. Elements in FIG. 2 that are identical or equivalent to the elements shown in FIG. 1 are referenced by the same reference marks.

In FIG. 2, the system control unit 1 performs a process of controlling each of units provided in this group-3 facsimile device (the network facsimile device FX), and performs a facsimile transmission control procedure process. The system memory 2 stores control process programs executed by the system control unit 1, and various types of data required when the process programs are executed, and forms a work area of the system control unit 1. The parameter memory 3 stores various types of information intrinsic to this group-3 facsimile device (the network facsimile device FX). The clock circuit 4 outputs current time information.

The scanner 5 reads a subject copy image with a predetermined resolution. The plotter 6 records and outputs an image with a predetermined resolution. The operation/display unit 7 comprises various types of operation keys and various types of displayer devices so as to operate this network facsimile device FX.

The encoding/decoding unit 8 encodes and compresses an image signal, and decodes encoded and compressed image information to the original image signal. The image storing device 9 stores a multitude of encoded and compressed image information.

The group-3 facsimile modem 10 realizes a modem function of the group-3 facsimile device, and has a low-speed modem function (V21 modem) to exchange a transmission procedure signal, and a high-speed modem function (V.17 modem, V.34 modem, V29 modem, V27 ter modem, etc.) to exchange image information.

The network control device 11 connects this network facsimile device FX to the analog public switched telephone network (PSTN), and has an automatic calling/answering function.

A local-area-network (LAN) interface circuit 21 connects this group-3 facsimile device to the local area network (LAN). A local-area-network (LAN) transmission control unit 22 performs a communication control process for predetermined types of protocol suites so as to exchange various types of data with other data terminal devices via the local area network (LAN).

The above-mentioned system control unit 1, the system memory 2, the parameter memory 3, the clock circuit 4, the scanner 5, the plotter 6, the operation/display unit 7, the encoding/decoding unit 8, the image storing device 9, the group-3 facsimile modem 10 and the network control device 11, the local-area-network (LAN) transmission control unit 22 are connected to the internal bus 12. These components exchange data mainly via this internal bus 12.

The network control device 11 and the group-3 facsimile modem 10 exchange data directly with each other.

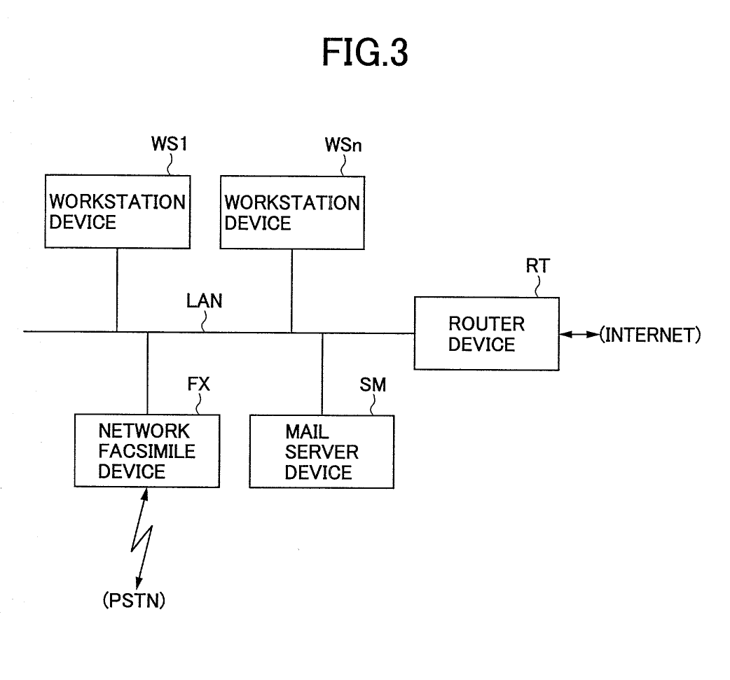

FIG. 3 shows an example of a network system including this group-3 facsimile device (the network facsimile device FX).

In FIG. 3, the local area network (LAN) is connected with a plurality of workstation devices WS1 to WSn, a mail server device SM, and the network facsimile device FX (the group-3 facsimile device shown in FIG. 2). The local area network (LAN) is also connected with the Internet via a router device RT. Accordingly, the workstation devices WS1 to WSn, the mail server device SM, and the network facsimile device FX can exchange data with other proper terminal devices via the Internet.

In this network system, the mail server device SM provides services of collecting and delivering well-known e-mail for users of the workstation devices WS1 to WSn and the network facsimile device FX connected with the local area network (LAN).

As mentioned above, the local area network (LAN) is connected with the Internet via the router device RT. Accordingly, the workstation devices WS1 to WSn, the mail server device SM, and the network facsimile device FX can exchange various types of data with such devices as host machines connected with other local area networks, etc.

Various programs, such as facsimile application software creating and displaying facsimile image information and various kinds of software for exchanging various types of data via the local area network (LAN) are installed in each of the workstation devices WS1 to WSn. Each of the workstation devices WS1 to WSn is used by particular user/users.

The network facsimile device FX has an e-mail processing function for exchanging image information and various reports as e-mail, and has a transmitting function of transmitting image information according to a group-3 -facsimile transmission procedure by connecting to the analog public switched telephone network (PSTN) and using this PSTN as a transmission path.

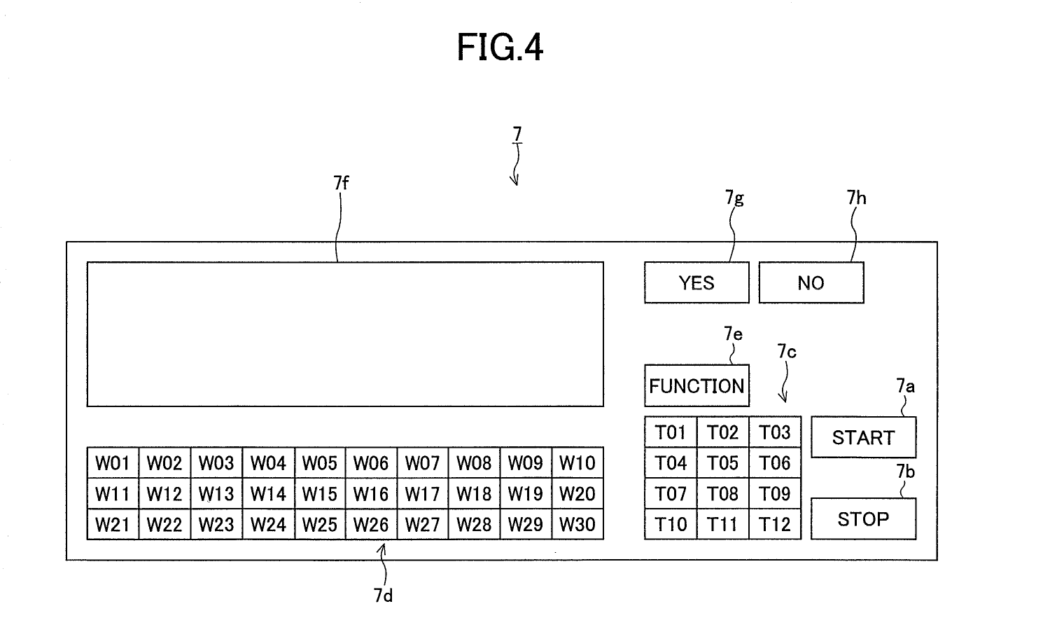

FIG. 4 shows an example of the operation/display unit 7.

In FIG. 4, a start key 7a is used to input a command to start a transmitting/receiving operation of this group-3 facsimile device. A stop key 7b is used to input a command to stop an operation of this group-3 facsimile device. A numeric keypad 7c is used to input numeric information, such as a telephone number.

A one-touch dial keyboard 7d is used to operate a one-touch dial function of designating a destination with one key-operation, and comprises three rows of ten keys, totaling 30 keys. A function key 7e is used to select from among various functions of this group-3 facsimile device, such as a data registration to the one-touch dial function.

A liquid-crystal display 7f displays various messages from this group-3 facsimile device to an operator. A YES-key 7g is used to input an affirmative response to a guidance message displayed on the liquid-crystal display 7f. A NO-key 7h is used to input a negative response to a guidance message displayed on the liquid-crystal display 7f.

The one-touch dial keyboard 7d is also used as a keyboard means upon keying in characters. Hereinbelow, a description will be given of a character arrangement (layout) in the one-touch dial keyboard 7d used as a keyboard means upon inputting characters.

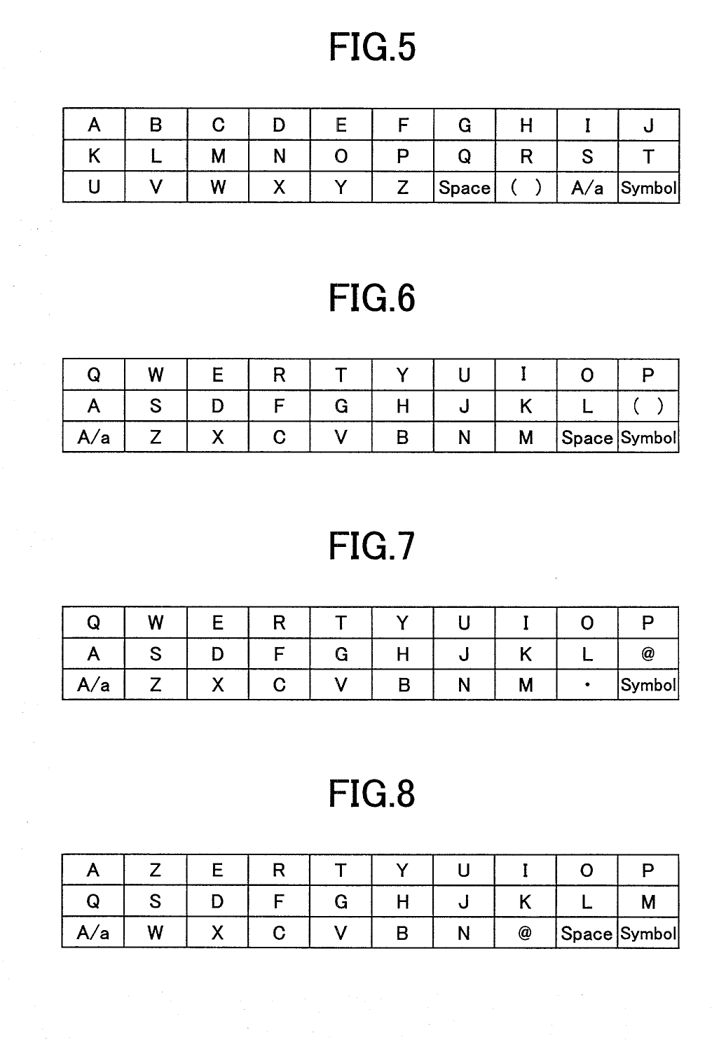

Conventionally, when characters, such as the alphabet, are arranged for use in this keyboard means, the characters are often arranged in an alphabetic-order character arrangement (hereinafter also referred to as “ABC character arrangement”) corresponding to an analphabetic order as shown in FIG. 5.

This alphabetic-order character arrangement is helpful for a user unaccustomed to a keyboard of a personal computer, for example, to key in alphabetic characters with looking thereat.

On the other hand, with the recent increase in the number of personal computer users, the personal computer users get accustomed to a keyboard of a personal computer. Therefore, the personal computer users can key in characters more effectively when a character arrangement in the keyboard of the personal computer (hereinafter referred to as “QWERTY character arrangement”) is adopted as the character arrangement of the keyboard means.

FIG. 6 shows an example of a mode of the character arrangement in the one-touch dial keyboard 7d adopting the above-mentioned QWERTY character arrangement corresponding to the character arrangement adopted in the keyboard of the personal computer.

In FIG. 6, an “A/a” key is used to toggle between an uppercase and a lowercase. A “Space” key is used to key in a space. A “Symbol” key is used to display a plurality of symbols, one by one, for each press.

As heretofore described, the mode of the character arrangement in the one-touch dial keyboard 7d can be changed in accordance with how accustomed the user is to a keyboard so that the user can key in characters with ease.

On the other hand, with the group-3 facsimile device shown in FIG. 2 having the function to connect to the local area network, there occurs a need for keying in an e-mail address.

In this case, it is preferable to adopt a character arrangement (hereinafter referred to as “Internet character arrangement”) in which “( )” and “Space” shown in FIG. 6 are replaced by “@” and “.” respectively, as shown in FIG. 7. “@” and “.” are symbols used in an e-mail address.

Thus, the group-3 facsimile device shown in FIG. 2 having the function to connect to the local area network to be used as the network facsimile device is preferred to adopt the “Internet character arrangement” shown in FIG. 7 as the character arrangement of the keyboard means.

That is, depending on a device arrangement (an option arrangement) of the group-3 facsimile device, the character arrangement adopted in the one-touch dial keyboard 7d upon keying in characters needs to be changed.

Further, depending on a nation where the group-3 facsimile device is situated, the character arrangement adopted in the one-touch dial keyboard 7d upon keying in characters needs to be changed.

For example, in France, a keyboard of a personal computer has a character arrangement in which a “Q” key and an “A” key are replaced by each other, a “W” key and a “Z” key are replaced by each other, and an “M” key is positioned at the right end of the middle row, compared with the QWERTY character arrangement.

Accordingly, when the group-3 facsimile device is situated in France, the character arrangement adopted in the one-touch dial keyboard 7d upon keying in characters can be set to a character arrangement shown in FIG. 8 (hereinafter referred to as “French character arrangement”), for example, so that the user can key in characters with ease.

Next, a description will be given of a character arrangement in the numeric keypad 7c.

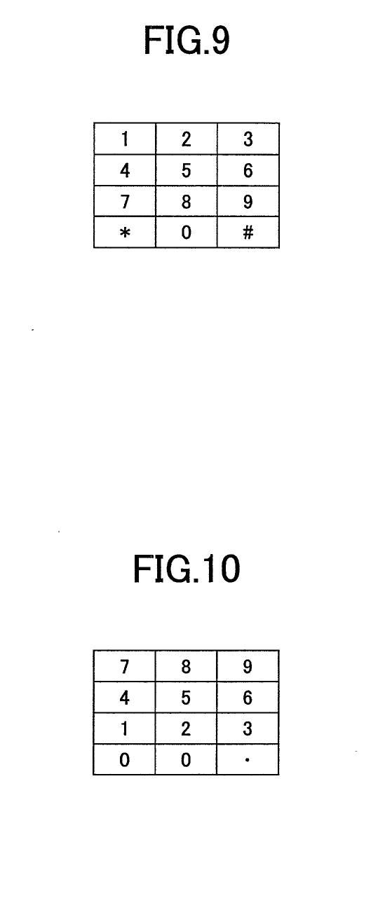

Normally, a numeric keypad of a communication apparatus has a character arrangement corresponding to a dial of a telephone, as shown in FIG. 9. Hereinafter, this character arrangement is referred to as “standard numeric-keypad arrangement”.

On the other hand, a numeric keypad of a data processing device, such as a personal computer or a pocket calculator, has a character arrangement as shown in FIG. 10. Hereinafter, this character arrangement is referred to as “extension numeric-keypad arrangement”.

Setting the character arrangement in the numeric keypad 7c of the group-3 facsimile device to the extension numeric-keypad arrangement can make it smooth for some users accustomed to the extension numeric-keypad arrangement to handle the numeric keypad 7c.

As described above, firstly, the character arrangement in the one-touch dial keyboard 7d used as the keyboard means upon inputting characters is preferred to be changed according to a user's preference, an arrangement of connected options, and a nation where the group-3 facsimile device is situated.

Secondly, the character arrangement in the numeric keypad 7c is preferred to be switched between the “standard numeric-keypad arrangement” and the “extension numeric-keypad arrangement” according to a user's preference.

In order to change the mode of the character arrangement in the one-touch dial keyboard 7d and the mode of the character arrangement in the numeric keypad 7c as described above, a predetermined key code is generated upon pressing each key of the one-touch dial keyboard 7d and the numeric keypad 7c, and a character code of a corresponding character is allocated for each key code.

In the one-touch dial keyboard 7d, the correspondence relations between these key codes and the character codes are arranged according to the above-mentioned ABC character arrangement, the QWERTY character arrangement, and the Internet character arrangement. In the numeric keypad 7c, the correspondence relations between these key codes and the character codes are arranged according to the above-mentioned standard numeric-keypad arrangement and the extension numeric-keypad arrangement. These correspondence relations can be changed according to a user's preference, and other conditions.

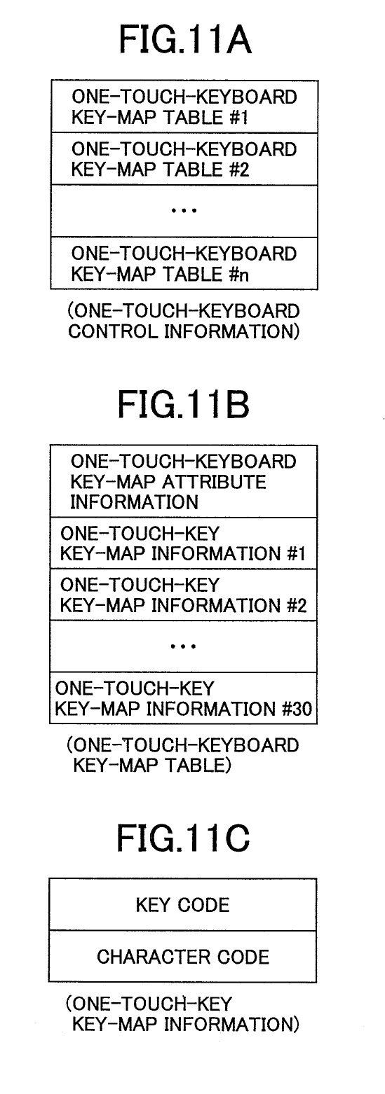

For that purpose, in the present embodiment, one-touch-keyboard control information as shown in FIG. 11A is provided for the one-touch dial keyboard 7d. The one-touch-keyboard control information includes a plurality of one-touch-keyboard key-map tables #1-#n storing the correspondence relations between the key codes and the character codes of each character arrangement.

As shown in FIG. 11B, each of the one-touch-keyboard key-map tables #1-#n includes one-touch-keyboard key-map attribute information representing an attribute (the ABC character arrangement, the QWERTY character arrangement, the Internet character arrangement, the French character arrangement, etc.) of the one-touch-keyboard key-map table, and one-touch-key key-map information #1-#30 representing allocation information for each of (one-touch) keys W01-W30.

As shown in FIG. 11C, each of the one-touch-key key-map information #1-#30 includes the key code corresponding to the one-touch key, and the character code corresponding to an allocated character.

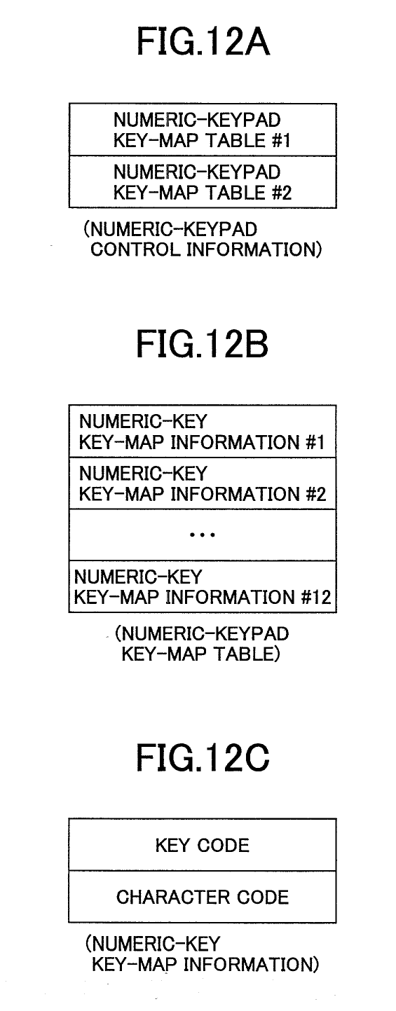

As for the numeric keypad 7c, numeric-keypad control information as shown in FIG. 12A is stored. The numeric-keypad control information includes numeric-keypad key-map tables #1 and #2 corresponding to the standard numeric-keypad arrangement and the extension numeric-keypad arrangement, respectively. As shown in FIG. 12B, each of the numeric-keypad key-map tables #1 and #2 includes numeric-key key-map information #1-#12 representing allocation information for each of (numeric) keys T01-T12.

As shown in FIG. 12C, each of the numeric-key key-map information #1-#12 includes the key code corresponding to the numeric key, and the character code corresponding to an allocated character (a numeral).

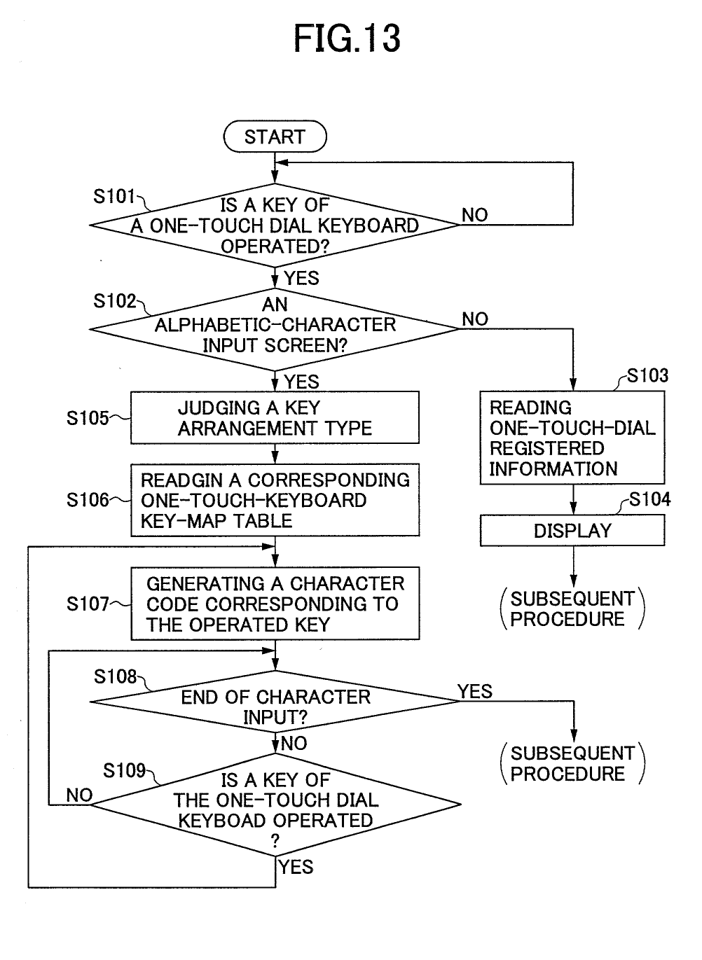

FIG. 13 shows an example of a procedure performed with the above-mentioned configuration, when a user operates the one-touch dial keyboard 7d.

When an operation of a key of the one-touch dial keyboard 7d is detected (Y in judgment S101), it is examined whether or not an input condition of the operation/display unit 7 is an alphabetic-character input screen (judgment S102).

When it is judged that the input condition of the operation/display unit 7 is not the alphabetic-character input screen (N in the judgment S102), one-touch-dial registered information corresponding to the operated key of the one-touch dial keyboard 7d is read from a predetermined one-touch dial table (not shown in the figures) (process S103), and is displayed then (process S104), followed by a subsequent procedure.

On the other hand, when it is judged that the input condition of the operation/display unit 7 is the alphabetic-character input screen (Y in the judgment S102), it is judged which of the ABC character arrangement and the QWERTY character arrangement is selected by the user as a key arrangement type (process S105). Then, the one-touch-keyboard key-map table corresponding to the character arrangement recognized in the process S105 is read from the one-touch-keyboard control information (process S106). Based on the read one-touch-keyboard key-map table, a character code corresponding to the operated key of the one-touch dial keyboard 7d is generated (process S107).

Subsequently, it is monitored whether or not the character input is finished (judgment S108). When it is judged that the character input is not finished (N in the judgment S108), it is monitored whether or not there is an operation of a key of the one-touch dial keyboard 7d (judgment S109). When it is judged that there is an operation of a key of the one-touch dial keyboard 7d (Y in the judgment S109), the process S107 is performed in which a character code corresponding to the present operated key of the one-touch dial keyboard 7d is generated. When it is judged that the character input is finished (Y in the judgment S108), a subsequent procedure follows.

As described above, in the present embodiment, the mode of the character arrangement in the one-touch dial keyboard 7d upon inputting characters can be set to either of the ABC character arrangement and the QWERTY character arrangement selected by a user; therefore, the user can input characters smoothly.

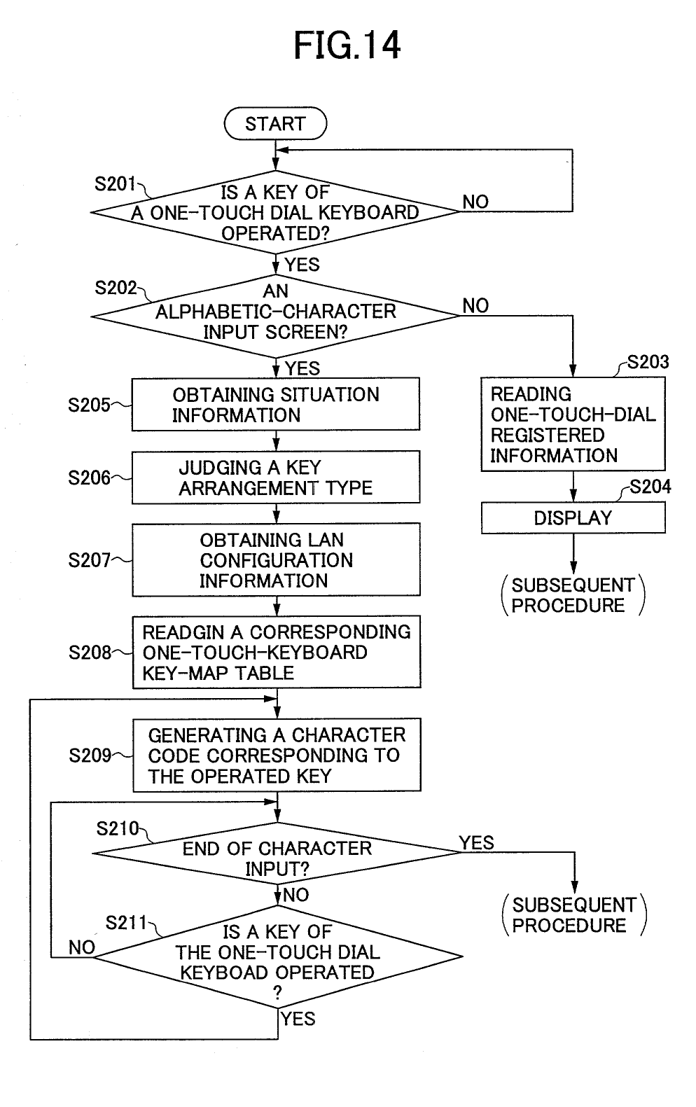

FIG. 14 shows another example of a procedure when a user operates the one-touch dial keyboard 7d.

When an operation of a key of the one-touch dial keyboard 7d is detected (Y in judgment S201), it is examined whether or not an input condition of the operation/display unit 7 is an alphabetic-character input screen (judgment S202).

When it is judged that the input condition of the operation/display unit 7 is not the alphabetic-character input screen (N in the judgment S202), one-touch-dial registered information corresponding to the operated key of the one-touch dial keyboard 7d is read from the predetermined one-touch dial table (not shown in the figures) (process S203), and is displayed then (process S204), followed by a subsequent procedure.

On the other hand, when it is judged that the input condition of the operation/display unit 7 is the alphabetic-character input screen (Y in the judgment S202), destination information (situation information regarding a nation where the group-3 facsimile device is to be situated) set in the group-3 facsimile device is obtained (process S205). Then, it is judged which of the ABC character arrangement and the QWERTY character arrangement is selected by the user as a key arrangement type (process S206). Further, configuration information is obtained with respect to whether or not the group-3 facsimile device has the structure to connect to the local area network as an optional function (process S207).

Then, the one-touch-keyboard key-map table corresponding to the destination information (the situation information) obtained in the process S205, the character arrangement recognized in the process S206, and the configuration information regarding the structure to connect to the local area network obtained in the process S207, is read from the one-touch-keyboard control information (process S208). Based on the read one-touch-keyboard key-map table, a character code corresponding to the operated key of the one-touch dial keyboard 7d is generated (process S209).

Subsequently, it is monitored whether or not the character input is finished (judgment S210). When it is judged that the character input is not finished (N in the judgment S210), it is monitored whether or not there is an operation of a key of the one-touch dial keyboard 7d (judgment S211). When it is judged that there is an operation of a key of the one-touch dial keyboard 7d (Y in the judgment S211), the process S209 is performed in which a character code corresponding to the present operated key of the one-touch dial keyboard 7d is generated. When it is judged that the character input is finished (Y in the judgment S210), a subsequent procedure follows.

As described above, in the present embodiment, the mode of the character arrangement in the one-touch dial keyboard 7d upon inputting characters can be set according to the destination (nation) of the group-3 facsimile device, the character arrangement selected by the user (the ABC character arrangement or the QWERTY character arrangement), and the presence of the structure to connect to the local area network; therefore, the user can smoothly input, not only characters, but also necessary symbols.

For example, in a case where the destination of the group-3 facsimile device is Japan or an English-spoken nation (Britain, United States, etc.), i.e., in a case where the group-3 facsimile device is to be situated in Japan or an English-spoken nation, and when the group-3 facsimile device has the structure to connect to the local area network, the Internet character arrangement is adopted. In the above-mentioned case, but when the group-3 facsimile device does not have the structure to connect to the local area network, the ABC character arrangement is adopted if the user selects the ABC character arrangement, or the QWERTY character arrangement is adopted if the user selects the QWERTY character arrangement.

As another example, in a case where the group-3 facsimile device is to be situated in an French-spoken nation (France, Indo-Chinese nations, etc.), and when the group-3 facsimile device has the structure to connect to the local area network, the Internet character arrangement is adopted. In the above-mentioned case, but when the group-3 facsimile device does not have the structure to connect to the local area network, the ABC character arrangement is adopted if the user selects the ABC character arrangement, or the French character arrangement is adopted if the user selects the QWERTY character arrangement.

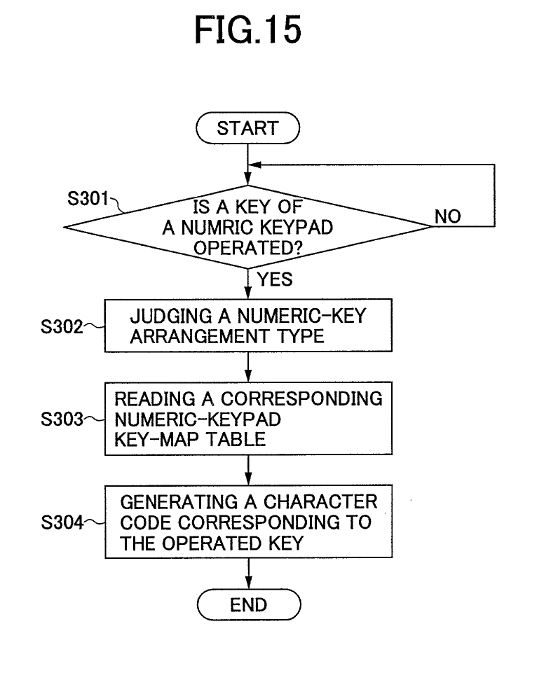

FIG. 15 shows an example of a procedure when a user operates the numeric keypad 7c.

When an operation of a key of the numeric keypad 7c is detected (Y in judgment S301), it is judged which of the standard numeric-keypad arrangement and the extension numeric-keypad arrangement is selected by the user as a numeric-key arrangement type (process S302). Then, the numeric-keypad key-map table corresponding to the character arrangement recognized in the process S302 is read from the numeric-keypad control information (process S303). Based on the read numeric-keypad key-map table, a character code corresponding to the present operated key of the numeric keypad 7c is generated (process S304). Then, this procedure is ended.

As described above, in the present embodiment, the mode of the character arrangement in the numeric keypad 7c upon inputting numerals can be set to either of the standard numeric-keypad arrangement and the extension numeric-keypad arrangement selected by a user; therefore, the user can input numerals smoothly.

By the way, in the above-described embodiment, since the character arrangements to be adopted in the one-touch dial keyboard 7d and the numeric keypad 7c are unsettled, it is difficult to stamp or print particular characters on the surfaces of the one-touch dial keyboard 7d and the numeric keypad 7c.

Thereupon, indication fields are provided on the above-mentioned surfaces of the one-touch dial keyboard 7d and the numeric keypad 7c so as to indicate allocated characters. Labels can be applied to the indication fields so that the user can smoothly operate the one-touch dial keyboard 7d and the numeric keypad 7c.

In this case, the above-mentioned labels may be recorded and output by the plotter 6 of the group-3 facsimile device.

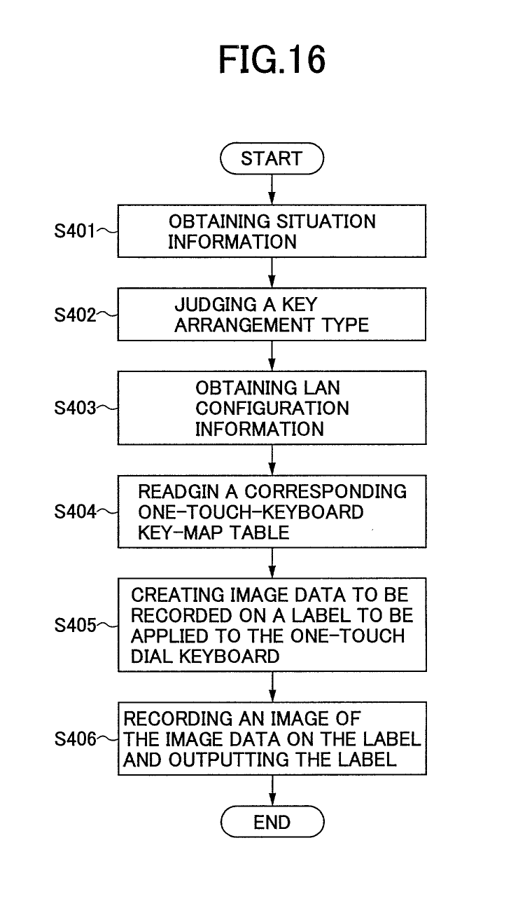

FIG. 16 shows an example of a procedure of recording and outputting the label to be applied to the indication field of the one-touch dial keyboard 7d.

First, the destination information (the situation information regarding a nation where the group-3 facsimile device is to be situated) set in the group-3 facsimile device is obtained (process S401). Then, it is judged which of the ABC character arrangement and the QWERTY character arrangement is selected by the user as a key arrangement type (process S402). Further, configuration information is obtained with respect to whether or not the group-3 facsimile device has the structure to connect to the local area network as an optional function (process S403).

Then, the one-touch-keyboard key-map table corresponding to the destination information (the situation information) obtained in the process S401, the character arrangement recognized in the process S402, and the configuration information regarding the structure to connect to the local area network obtained in the process S403, is read from the one-touch-keyboard control information (process S404). Based on the read one-touch-keyboard key-map table, image data to be recorded on the label in this case is created (process S405). Then, an image corresponding to the image data is recorded on the label, and the label is output, by the plotter 6 (process S406).

The above-mentioned image recorded and output on the above-mentioned label to be applied to the indication field of the one-touch dial keyboard 7d will be an image, for example, shown in FIG. 5, FIG. 6, FIG. 7 or FIG. 8.

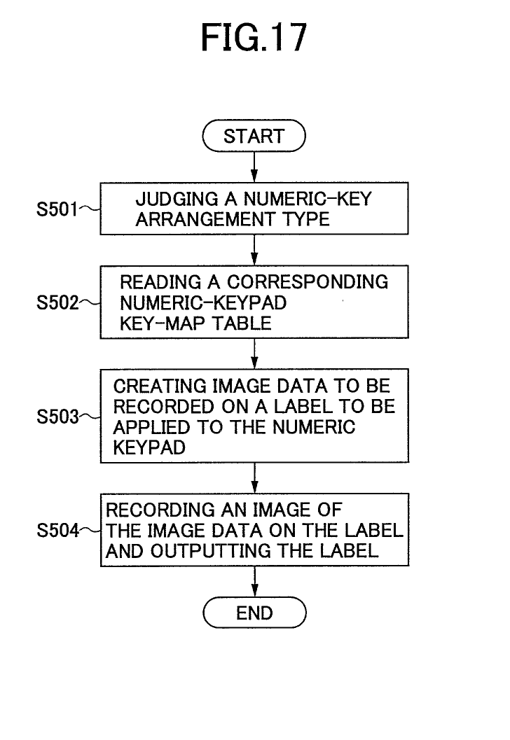

FIG. 17 shows an example of a procedure of recording and outputting the label to be applied to the indication field of the numeric keypad 7c.

First, it is judged which of the standard numeric-keypad arrangement and the extension numeric-keypad arrangement is selected by the user as a numeric-key arrangement type (process S501). Then, the numeric-keypad key-map table corresponding to the character arrangement recognized in the process S501 is read from the numeric-keypad control information (process S502). Based on the read numeric-keypad key-map table, image data to be recorded on the label in this case is created (process S503). Then, an image corresponding to the image data is recorded on the label, and the label is output, by the plotter 6 (process S504).

The above-mentioned image recorded and output on the above-mentioned label to be applied to the indication field of the numeric keypad 7c will be an image, for example, shown in FIG. 9 or FIG. 10.

In addition, a one-touch switching plate, for example, can be utilized so that the user can selectively switch the type of the character arrangement at any time while using the group-3 facsimile device. This makes the group-3 facsimile device more practical.

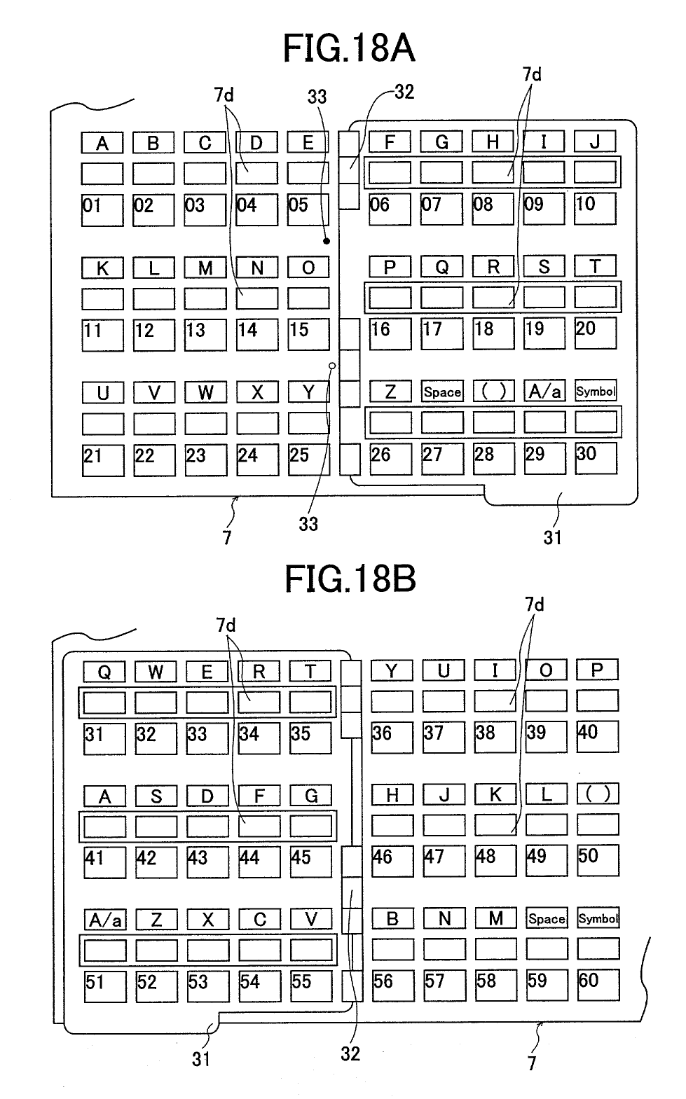

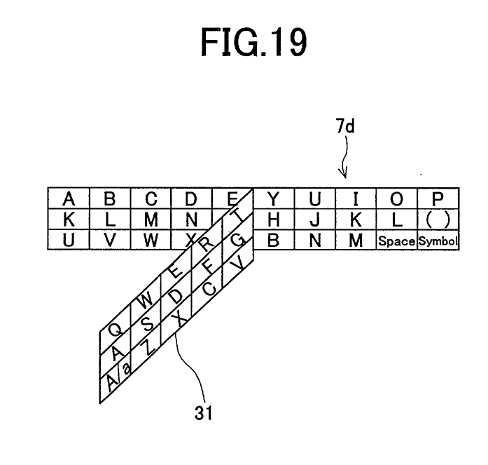

FIG. 18A, FIG. 18B and FIG. 19 show an example of a structure in the vicinity of the one-touch dial keyboard 7d of the operation/display unit 7 utilizing a one-touch switching plate 31. FIG. 18A and FIG. 18B are plan views specifically showing the structure. FIG. 19 is an explanatory view plainly showing an opening/closing of the one-touch switching plate 31. In the operation/display unit 7, also for the purpose of increasing the number of registrable one-touch dials, the one-touch switching plate 31 is provided on the one-touch dial keyboard 7d such that the one-touch switching plate 31 can be revolved right and left around fulcra 32. Thereby, a total of the 30 keys including the three rows of the ten keys can have 30 one-touch dials 01-30 as shown in FIG. 18A, and, when the one-touch switching plate 31 is revolved to the left, can have another 30 one-touch dials 31-60 as shown in FIG. 18B, totaling 60 one-touch dials. Whether the one-touch switching plate 31 is revolved to the right or left is detected by a detection switch 33, such as a microswitch, which is turned on when pressed by the one-touch switching plate 31 revolved to the left. Specifically, when the detection switch 33 is not pressed (turned off), the 30 keys of the one-touch dial keyboard 7d correspond to the one-touch dials 01-30 as shown in FIG. 18A, and when the detection switch 33 is pressed (turned on), the 30 keys of the one-touch dial keyboard 7d correspond to the one-touch dials 31-60 as shown in FIG. 18B.

Further, in the present embodiment, when the one-touch switching plate 31 is revolved to the right as shown in FIG. 18A, the 30 keys of the one-touch dial keyboard 7d assume the ABC character arrangement, and when the one-touch switching plate 31 is revolved to the left as shown in FIG. 18B, the 30 keys of the one-touch dial keyboard 7d assume the QWERTY character arrangement. That is, the character arrangement to be used can be selectively switched by using the one-touch switching plate 31. It is recognized, also based on the detection switch 33 being turned off/on, which of the ABC character arrangement and the QWERTY character arrangement is selected (as in the above-mentioned processes S105, S206, etc.). Thereby, two modes of the character arrangements can be selectively switched at any time.

Besides, when the key arrangement includes an even number of rows, such as four rows, a one-touch switching plate can be provided on the one-touch dial keyboard 7d such that the one-touch switching plate can be revolved up and down. Additionally, a one-touch switching plate can be provided on the numeric keypad 7c in a similar manner.

Although the above-described embodiment is an application of the present invention to the group-3 facsimile device, the present invention can be also applied to other communication devices, such as a group-4 facsimile device or a telephone.

In addition, it can be arranged that, when the character arrangement is switched according to the above-mentioned destination information (the situation information), a character arrangement of other language be selected. Additionally, other layouts, such as a so-called DVORAK layout, can be adopted as a standard layout.

The present invention is not limited to the specifically disclosed embodiments, and variations and modifications may be made without departing from the scope of the present invention.

The present application is based on Japanese priority applications No. 2000-332296 filed on Oct. 31, 2000 and No. 2001-196904 filed on Jun. 28, 2001, the entire contents of which are hereby incorporated by reference.

What is claimed is:

1. A communication device comprising:
a keyboard used to input literal information,
wherein a character allocated to each of keys provided on said keyboard can be changed.

2. The communication device as claimed in claim 1, wherein the character is allocated to each of said keys according to a predetermined keyboard character layout.

3. The communication device as claimed in claim 2, wherein said predetermined keyboard character layout is selected from among a plurality of predetermined keyboard character layouts by a user.

4. The communication device as claimed in claim 3, wherein configuration information regarding a configuration of the communication device is obtained so that said predetermined keyboard character layout is selected according to said configuration information.

5. The communication device as claimed in claim 3, wherein situation information regarding a nation where the communication device is situated is obtained so that said predetermined keyboard character layout is selected according to said situation information.

6. The communication device as claimed in claim 3, wherein configuration information regarding a configuration of the communication device is obtained, and situation information regarding a nation where the communication device is situated is obtained, so that said predetermined keyboard character layout is selected according to at least one of said configuration information and said situation information.

7. A communication device comprising:
a numeric keypad used to input numeric information,
wherein a character allocated to each of keys provided on said numeric keypad can be changed.

8. The communication device as claimed in claim 7, wherein the character is allocated to each of said keys according to a predetermined numeric-keypad character layout.

9. The communication device as claimed in claim 8, wherein said predetermined numeric-keypad character layout is selected from among a plurality of predetermined numeric-keypad character layouts by a user.
